(19) United States
(12) Patent Application Publication
(10) Pub. No.: US 2016/0134621 A1
(43) Pub. Date: May 12, 2016

(54) CERTIFICATE PROVISIONING FOR AUTHENTICATION TO A NETWORK

(71) Applicant: QUALCOMM Incorporated, San Diego, CA (US)

(72) Inventor: Anand Palanigounder, San Diego, CA (US)

(21) Appl. No.: 14/795,635

(22) Filed: Jul. 9, 2015

Related U.S. Application Data
(60) Provisional application No. 62/078,909, filed on Nov. 12, 2014.

(51) Int. Cl. H04L 29/06

(52) U.S. Cl. CPC H04L 63/0823; H04L 63/0876; H04L 63/045; H04L 63/0485; H04L 63/029; H04L 63/166

(57) ABSTRACT

A method for authenticating a device to a network using a device certificate is described. The method includes generating a private-public key pair on a system-on-chip (SoC) of the device. The private key is protected by a hardware-based root of trust of the SoC. The method also includes generating a device certificate that is signed using the private key. The method further includes using the device certificate to gain access to the network.

### RELATED APPLICATIONS

This application is related to and claims priority from U.S. Provisional Patent Application Ser. No. 62/078,909, filed Nov. 12, 2014, for “Certificate Provisioning for Authentication to a Network.”

### INTRODUCTION

The present disclosure relates generally to the field of communications, and more specifically, to systems and methods for authenticating a mobile device to a network using a device certificate.

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmission power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long-term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

To supplement conventional base stations, additional low-power base stations can be deployed to provide more robust wireless coverage to mobile devices. For example, low-power base stations (e.g., which can be commonly referred to as Home NodeBs or Home eNBs, collectively referred to as H(e)NBs, small nodes, small cell nodes, pico nodes, micro nodes, etc.) can be deployed for incremental capacity growth, richer user experience, in-building or other specific geographic coverage, and/or the like. In some configurations, such low-power base stations are connected to the Internet via broadband connection (e.g., digital subscriber line (DSL) router, cable or other modem, etc.), which can provide the backhaul link to the mobile operator's network. In this regard, low-power base stations are often deployed in homes, offices, etc. without consideration of a current network environment.

Before accessing a wireless communication network, a mobile device may be required to authenticate. In many wireless communication networks, authentication may be performed using a subscriber identity module (SIM) card provided by the network operator. Some wireless communication networks, such as neutral host (NH) networks, may need to allow a mobile device to connect and securely authenticate without the use of a SIM card. Thus, systems and methods for authenticating a mobile device to a network using a device certificate may be beneficial.

### SUMMARY

A method for authenticating a device to a network using a device certificate is described. The method includes generating a private-public key pair on a system-on-chip (SoC) of the device. The private key is protected by a hardware-based root of trust of the SoC. The method also includes generating a device certificate that is signed using the private key. The method further includes using the device certificate to gain access to the network.

The device certificate may include an SoC identifier. The device certificate may also include the generated public key. The private-public key pair may be generated using a primary hardware key. The device certificate may be formatted as an X.509 certificate.

The network may be a neutral host (NH) network. The NH network may be a long-term evolution (LTE) NH network. The NH network may be an Institute of Electrical and Electronics Engineers (IEEE) 802.11 (WiFi) access network.

Using the device certificate to gain access to the network may include sending an access request to the network. A network certificate may be received from the network. The network certificate may be validated. The device certificate may be sent to the network. Access to the network may be received based on the device certificate.

The steps of sending an access request to the network, receiving a network certificate from the network, validating the network certificate, sending the device certificate to the network, and receiving access to the network based on the device certificate may be performed using extensible authentication protocol (EAP) over a non-access stratum (NAS) of an LTE network.

The steps of sending an access request to the network, receiving a network certificate from the network, validating the network certificate, sending the device certificate to the network, and receiving access to the network based on the device certificate may be performed using EAP-TLS (Transport Layer Security) or EAP-TTLS (Tunneled Transport Layer Security).

In one implementation, generating the private-public key pair may be performed before activating NH network service. In another implementation, generating the private-public key pair may be performed during device manufacture. In yet another implementation, generating the private-public key pair may be performed during SoC manufacture.

In one implementation, generating the device certificate may be performed during a first boot of the device. In another implementation, generating the device certificate may be performed during activation of NH network service. In yet another implementation, generating the device certificate may be performed as part of authentication to the network.

An apparatus for authenticating a device to a network using a device certificate is also described. The apparatus includes a key generator configured to generate a private-public key pair on a SoC of the device. The private key is protected by a hardware-based root of trust of the SoC. The apparatus also includes a certificate generator configured to generate a device certificate that is signed using the private key. The apparatus further includes a transceiver configured to use the device certificate to gain access to the network.

Another method for authenticating a device to a network using a device certificate is described. The method includes receiving a device certificate from a device. The device certificate is signed using a private key of the device. The method also includes validating the device certificate using a SoC-specific device identifier and a public key of the device included in the device certificate.

Validating the device certificate may include performing a lookup in a database. The lookup may be performed over a trusted out-of-band channel. In one implementation, the out-of-band channel may use hypertext transfer protocol secure (HTTPS). In another implementation, the lookup may be performed in a local database in the network. The lookup may be performed by generating a hash of the SoC identifier, the public key and a database-specific seed value.

An apparatus for authenticating a device to a network using a device certificate is described. The apparatus includes a transceiver configured to receive a device certificate from a device. The device certificate is signed using a private key of the device. The apparatus also includes a certificate validator configured to validate the device certificate using a SoC-specific device identifier and a public key of the device included in the device certificate.

### BRIEF DESCRIPTION OF THE DRAWINGS

FIG. 1 is a block diagram illustrating an example communication system;

FIG. 2 is a block diagram illustrating an example device;

FIG. 3 is a block diagram illustrating an example authentication server;

FIG. 4 is a flow diagram illustrating one configuration of a method for authenticating a device to a network using a device certificate;

FIG. 5 is a flow diagram illustrating another configuration of a method for authenticating a device to a network using a device certificate;

FIG. 6 is a sequence diagram illustrating a procedure for certificate-based authentication;

FIG. 7 shows certain components that may be included in a device; and

FIG. 8 shows certain components that may be included in an authentication server.

### DETAILED DESCRIPTION

In LTE networks, currently the only way to authenticate a device is to use a SIM card provided by a particular mobile network operator. However, for neutral host (NH) LTE networks, there is a need to allow any device to connect and securely authenticate itself to any NH LTE network. This needs to be possible without relying on a SIM card and without requiring the device to be provisioned with credentials specific to an NH network.

The systems and methods described herein provide for authenticating a device to a network by using a device certificate. The device may generate a private-public key pair on a system-on-chip (SoC). The private key may be protected by the hardware-based root of trust of the SoC. The device may generate a device certificate that is signed using the private key. The device may then use the device certificate to gain access to the network.

Various aspects are now described with reference to the drawings. In the following description, for purposes of explanation, numerous specific details are set forth in order to provide a thorough understanding of one or more aspects. It may be evident that such aspect(s) may be practiced without these specific details.

In various aspects, systems and methods for authenticating a mobile device to a network using a device certificate are described. The description may refer to a device. A device can also be called a system, device, subscriber unit, subscriber station, mobile station, mobile, remote station, mobile terminal, remote terminal, access terminal, user terminal, terminal, communication device, user agent, user device or user equipment (UE). A device may be a cellular telephone, a satellite phone, a cordless telephone, a Session Initiation Protocol (SIP) phone, a wireless local loop (WLL) station, a personal digital assistant (PDA), a handheld device having wireless connection capability, a tablet, a computing device or other processing devices connected via a wireless modem to one or more base stations (BS) that provide cellular or wireless network access to the device.

A base station (BS) may be utilized for communicating with device(s) and may also be referred to as an access point, small node, a pico node, micro node, a Node B, evolved Node B (eNB), home Node B (HNB) or home evolved Node B (HeNB), collectively referred to as H(e)NB, or some other terminology. These base stations may be considered low-power base stations. For example, a low-power base station may transmit at a relatively low power as compared to a macro base station associated with a wireless wide area network (WWAN). As such, the coverage area of the low-power base station can be substantially smaller than the coverage area of a macro base station.

The techniques described herein may be used for various wireless communication systems such as CDMA, TDMA, FDMA, OFDMA, single-carrier frequency division multiple access (SC-FDMA), Wi-Fi carrier sense multiple access (CSMA), and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95, and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, Bluetooth and any other short- or long-range, wireless communication techniques.

Various aspects or features will be presented in terms of systems that may include a number of devices, components, modules, and the like. It is to be understood and appreciated that the various systems may include additional devices, components, modules, etc., and/or may not include all of the devices, components, modules, etc. discussed in connection with the figures. A combination of these approaches may also be used.

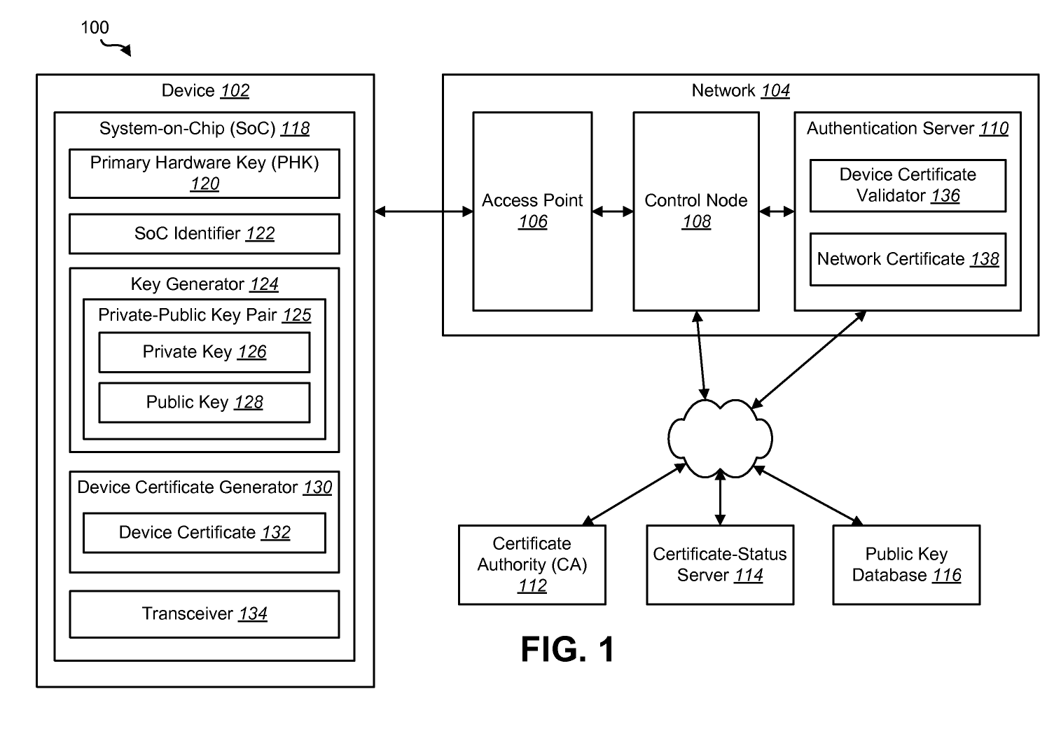

FIG. 1 is a block diagram illustrating an example wireless communication system 100. The wireless communication system 100 may include one or more of a device 102, a network 104, a certificate authority (CA) 112, a certificate-status server 114, and a public key database 116. It may also include other devices or network nodes not illustrated. The network 104 may include one or more of an access point 106, a control node (CN) 108 and an authentication server 110. The device 102, access point 106, control node 108, authentication server 110, certificate authority 112, certificate-status server 114, and public key database 116 may communicate over one or more wired or wireless links.

The wireless communication system 100 may be a multiple-access system capable of supporting communication with multiple wireless devices 102 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

A device 102 may also be referred to as a wireless communication device, a mobile device, mobile station, subscriber station, client, client station, user equipment (UE), remote station, access terminal, mobile terminal, terminal, user terminal, subscriber unit, etc. Examples of wireless devices 102 include laptop or desktop computers, cellular phones, smart phones, wireless modems, e-readers, tablet devices, gaming systems, etc. Some of these devices 102 may operate in accordance with one or more industry standards.

Communications in the wireless communication system 100 may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. In some configurations, the wireless communication system 100 may utilize MIMO. A MIMO system may support time division duplex (TDD) and/or frequency division duplex (FDD) systems.

In some configurations, the wireless communication system 100 may operate in accordance with one or more standards. Examples of these standards include Bluetooth (e.g., Institute of Electrical and Electronics Engineers (IEEE) 802.15.1), IEEE 802.11 (Wi-Fi), IEEE 802.16 (Worldwide Interoperability for Microwave Access (WiMAX), Global System for Mobile Communications (GSM), Universal Mobile Telecommunications System (UMTS), CDMA2000, Long Term Evolution (LTE), etc.

In LTE networks, a subscriber identity module (SIM) card provided by a mobile network operator may be used to authenticate a device 102 to a network 104. However, for neutral host (NH) networks, there may be a need to allow a device 102 to connect and securely authenticate to any NH network without a SIM card and without pre-provisioning of network-specific credentials.

A NH network may be a set of NH access networks that are managed by or have a roaming relationship with a NH network service provider. A NH access network may be locally owned and operated, for example, by a cable operator or an enterprise, as a hotspot, or in a residence. In one example, a NH network may be a small cell network that allows access to devices 102 from other network operators.

As used herein, a small cell may include one or more low-powered radio access points 106 that operate in licensed or unlicensed spectrum. A small cell may be centrally managed by a network operator. A small cell may have a range of 10 meters to 1 or 2 kilometers. A small cell is “small” compared to a macro cell, which may cover a relatively large geographic area (e.g., several kilometers in radius) and may allow unrestricted access by devices 102 with service subscriptions with a network provider.

Small cells may include pico cells, femto cells, and micro cells according to various examples. A pico cell may cover a relatively smaller geographic area and may allow unrestricted access by devices 102 with service subscriptions with the network provider. A micro cell may cover an area larger than a pico cell. A femto cell also may cover a relatively small geographic area (e.g., a home) and may provide restricted access by devices 102 having an association with the femto cell (e.g., devices 102 in a closed subscriber group (CSG), devices 102 for users in the home, and the like). The small cell network may be installed at a specific venue (e.g., a mall, a stadium, or a business) and may provide enhanced coverage or capacity.

The network 104 described herein may be a NH network. In one implementation, the network 104 may be an LTE NH network. In another implementation, the network 104 may be an IEEE 802.11 (e.g., WiFi) access network.

In one configuration, the network 104 may authenticate the device 102 before the device 102 is permitted to use services on the network 104. For example, the network 104 may authenticate the device 102 based on a device certificate 132. In another configuration, the device 102 and NH network may authenticate each other before the device 102 is permitted to use services on the NH network. For example, the device 102 may authenticate the NH network based on a network certificate 138, and the NH network may authenticate the device 102 based on a device certificate 132.

Certificate-based authentication of the NH network 104 may prevent the network 104 from masquerading as another network. The certificate-based authentication process may ensure that user identity privacy (i.e., device 102 identity) is no worse than in an LTE network. For example, the process may not send information in the clear that may be used to identify the user or the device 102. In other words, a passive eavesdropper or the NH access network 104 may not have access to the information that may be used to track the user or the device 102.

To gain access to the network 104, the device 102 may need to be authenticated by the network 104. Authentication may be performed using a unique device certificate 132 associated with the device 102. The device 102 may use the device certificate 132 for authentication to the network 104 in lieu of subscriber identity module (SIM)-based authentication. Therefore, provisioning the device 102 with a secure device certificate 132 may be beneficial.

In one configuration, the device 102 may include a system-on-chip (SoC) 118. A SoC 118 may be an integrated circuit that integrates all of the components of a computer or electronic system into a single chip. An SoC 118 may include hardware and software for controlling the hardware. The SoC 118 may include one or more processors (e.g., application processor, digital signal processor, graphics processing unit), memory (e.g., read-only memory (ROM), random-access memory (RAM), electrically erasable programmable read-only memory (EEPROM) and flash memory), timing sources (e.g., oscillators and phase-locked loops (PLLs)), peripherals and interfaces (e.g., analog-to-digital converters (ADCs) and digital-to-analog converters (DACs)). The SoC 118 may additionally include a transceiver 134 and modem to perform wireless communication functions. The hardware of the SoC 118 may be integrated in a single chip substrate.

The use of an SoC 118 may reduce system complexity, cost, and power consumption. Furthermore, an SoC may save space on the device 102.

The SoC 118 may be identified by an SoC identifier 122. In one implementation, the SoC identifier 122 may be a unique serial number of the SoC 118. In one example, the chip serial number may be a 32-bit number. In another implementation, the SoC identifier 122 may be a device-unique serial number.

The SoC 118 may also include a trusted execution environment (e.g., as described by GlobalPlatform specifications). A trusted execution environment may be an isolated area or execution environment of the SoC 118 that provides a higher level of security than the rich mobile operating system of the device 102. For example, the trusted execution environment may provide isolated execution and may protect the confidentiality and integrity of code and data within the trusted execution environment even if the rich mobile operating system of the device 102 is compromised.

The SoC 118 may also include a primary hardware key (PHK) 120 that is stored in one-time programmable memory of the SoC 118. The PHK 120 may be a number randomly generated by the SoC 118 and stored in the one-time programmable memory of the SoC 118.

The device may generate one or more private-public key pairs 125 using the PHK 120. A private-public key pair 125 may include a private key 126 and a public key 128. The device 102 may leverage the PHK 120 to generate one or more private-public key pairs 125 using asymmetric cryptosystems, such as Rivest-Shamir-Adleman (RSA) or elliptic curve cryptography (ECC). Therefore, the one or more private-public key pairs 125 may be ECC or RSA private-public key pairs 125. The SoC 118 may include a key generator 124 that generates the one or more private-public key pairs 125.

The private keys 126 may be protected by the trusted execution environment. The initial source of trust (also referred to as “roots of trust”) for a trusted execution environment may be provided by the SoC hardware. Systems or execution environments that depend on such hardware for their roots of trust are also referred to as hardware-based root of trust. In this way, the private keys may be protected by a hardware-based root of trust. A hardware-based root of trust may be used to provide one or more security functions. These security functions may include verifying software, protecting cryptographic keys and performing device authentication.

It should be noted that in some approaches, a hardware-based root of trust may be achieved by using a separate module. For example, trusted platform module (TPM) uses a dedicated chip with a microprocessor to provide one or more security functions. However, the TPM chip is a separate unit that is combined with the secured hardware. Alternatively, the trusted execution environment of the SoC 118, as described herein, provides an intrinsic hardware-based root of trust on the SoC 118 without the need for a separate unit. Because the SoC 118 is produced as a single unit, security may be enhanced by using a hardware-based root that is integral to (not separate from) the SoC 118.

The one or more private-public key pairs 125 may include an authentication key pair that may be used to authenticate the SoC 118 and/or the device 102. The one or more private-public key pairs 125 may also include an encryption key pair that may be used to securely provision service-specific secret keys or other secret information to the device 102.

The device 102 may generate the one or more private-public key pairs 125 at various times. For example, the device 102 may generate the one or more private-public key pairs 125 before activating service on a network 104 (e.g., a NH network) or the first boot of the device 102. In another example, the authentication or encryption key pairs 125 may be generated during the manufacturing of the SoC 118. In yet another example, the device 102 may generate the one or more private-public key pairs 125 during device 102 manufacture. The public keys 128, along with the SoC identifier 122 (e.g., SoC serial number or other device-unique serial number), may be stored in a public key database 116 for subsequent use.

The device 102 may generate a device certificate 132. For example, the device 102 may include a device certificate generator 130 that generates the device certificate 132.

In one implementation, the device certificate 132 may be formatted as an X.509 certificate. The device certificate 132 may also be formatted in other known formats. The device certificate 132 may include the SoC identifier 122 and the public key 128. For example, the generated device certificate 132 may include the authentication public key 128 of the authentication private-public key pair 125 in a Public Key field of the X.509 certificate. The generated device certificate 132 may be identified based on the SoC identifier 122 (e.g., chip serial number or device-unique serial number) in a Serial Number, Subject, and/or subjectAltName field of the X.509 certificate.

The generated device certificate 132 may be signed using the private key 126. For example, the device certificate 132 may be signed using the authentication private key 126 of the authentication private-public key pair 125. In this way, the device certificate 132 may be a self-signed device certificate 132. It should be noted that because the private key 126 is protected by the hardware-based root of trust of the SoC 118, the provisioning of the device certificate 132 may be secure and efficient.

In an example, the SoC 118 manufacturer may provide a secure hardware-based approach to generating and securing the private key 126. The device certificates 132 that are generated and signed using such private keys 126 can be used for device authentication without the need for external entities such as a certificate authority (CAs) 112. Operating a CA 112 for the device certificate 132 is inherently more complex, expensive and difficult to scale. Furthermore, the issuance of device certificates 132 from a CA 112 requires a secure channel between the device 102 and the CA 112. Such a channel may not be available if the device 102 does not have the credentials (e.g., a SIM card or a device certificate 132) to authenticate to the telecommunications network 104.

The device 102 may generate and sign the device certificate 132 at various times. For example, device 102 may generate and sign the device certificate 132 during a first boot of the device 102. In another example, the device 102 may generate and sign the device certificate 132 as part of activating NH network service of the device 102. In yet another example, the device 102 may generate and sign the device certificate 132 as part of the authentication process with the network 104.

In one configuration, the SoC 118 manufacturer may create a public key database 116. The public key database 116 may associate specific SoCs 118 with their public keys 128. In one configuration, the SoC 118 manufacturer may store, at the time of manufacture, the SoC identifier 122 (e.g., chip serial number(s)) and the public key(s) of the generated authentication and/or encryption private-public key pairs 125. With this information, the SoC 118 manufacturer may create a public key database 116. The public key database 116 may store, for each SoC 118, the SoC identifier 122 and public keys 128 generated using the PHK 120.

In another configuration, the public key database 116 may store this information as a list of hash entries with each hash value identifying a specific SoC 118. For example, the hash value for each SoC 118 may be generated as a secure hash algorithm (SHA) hash (e.g., SHA-256) that includes the SoC identifier 122, the public key 128 and a seed value. The seed value may be a database-specific well-known constant seed value.

In addition, the public key database 116 may include additional entries that are not associated with a device 102. These additional entries may be referred to as bogus entries. These additional entries may be added to the public key database 116 so that a user with access to the public key database 116 may not be able to discern the actual number of devices 102 with legitimate entries in the public key database 116.

By having the device 102 generate and sign its own device certificate 132, benefits may be realized. For example, there may be no need for a certificate authority 112 (CA) that issues device certificates 132. In addition, there may be no need for a secure connection (e.g., between the device 102 and the CA 112) in order to issue the device certificate 132. This may be important if the device 102 is attempting to connect to a NH network 104 and does not yet have a connection to contact a CA 112.

The device 102 may further be provided with a list of trusted certificate authorities (CAs) 112 that are authorized to issue network certificates 138 to NH network servers. This list may be a common list for all devices 102 that are able to connect to NH networks.

In one configuration, the device 102 may also be provided with the address of an online certificate status protocol (OCSP) server. The device 102 may use the address of the OCSP server to query the OCSP server to verify that a network certificate 138 has not been revoked. In another configuration, the device 102 may be provided with a certificate revocation list (CRL). The CRL may be a list of network certificates 138 or certificates of the network certificate CAs 112 that have been revoked. The device 102 may use the CRL to verify that a network certificate 138 has not been revoked.

The device 102 may communicate with the control node 108. In one configuration, the control node 108 may be a mobility management entity (MME). In this configuration, LTE non-access stratum (NAS) signaling may be enhanced to carry extensible authentication protocol (EAP) messages between the device 102 and the control node 108. The device 102 may indicate support for certificate-based authentication or neutral-host operation in an Attach message. The control node 108 may then use this indication to start a certificate-based authentication process between the device 102 and the authentication server 110. An LTE network that comprises such an enhanced control node 108 to support EAP-based authentication may be known as a neutral-host LTE network or NH LTE network.

In one configuration, the authentication server 110 may be an authentication, authorization, and accounting (AAA) server. In this configuration, the control node 108 (e.g., MME) may be enhanced to interface with the authentication server 110 (e.g., AAA server) using EAP. For example, the control node 108 may interface with the authentication server 110 using EAP and authenticate the device 102 using Transport Layer Security (EAP-TLS) as defined in IETF RFC 5216. In another example, the control node 108 may interface with the authentication server 110 using EAP and authenticate the device 102 using Tunneled Transport Layer Security (EAP-TTLS) as defined in IETF RFC 5281.

In one configuration, the TLS client authentication of the device 102 is performed by the authentication server 110 (e.g., AAA server) using the generated self-signed device certificate 132. In the EAP-TTLS method, further user authentication (e.g., username and password, secured ID token, or another well-known method of user authentication) may be performed by the authentication server 110 after TLS client authentication of the device 102 using the self-signed device certificates 132.

The EAP messages may be carried over remote authentication dial-in user service (RADIUS) or Diameter protocols between the control node 108 and the authentication server 110. At the conclusion of the authentication process, the authentication server 110 may send an EAP master session key (MSK) to the control node 108. The control node 108 may use the MSK to derive the key K_{ASME}, which may be used for LTE NAS and access stratum (AS) security as defined in 3GPP TS 33.401.

The authentication server 110 may be provided with access to the public key database 116 that stores the SoC identifier 122 (e.g., chip serial numbers(s)) and public keys 128 for one or more devices 102 with the self-signed device certificates 132. The authentication server 110 may query the public key database 116 to verify the authenticity of a self-signed device certificate 132.

In one configuration, the public key database 116 may reside on a separate network entity that may be inside or outside an operator network 104. In this configuration, the authentication server 110 may query the public key database 116 over a trusted out-of-band channel. The out-of-band channel may use a secure protocol, such as hypertext transfer protocol secure (HTTPS).

In another configuration, the authentication server 110 may include a local copy of the public key database 116, which it may access locally. In this configuration, validating the device certificate 132 may include performing a lookup in the public key database 116. In this case, the lookup is performed in the local public key database 116.

In yet another configuration, the verification may be performed by generating the hash (e.g., SHA-256 hash) of the SoC identifier 122, the public key 128 of the self-signed device certificate 132, and a database-specific seed value. The authentication server 110 may perform a lookup of the public key database 116 using this generated hash.

The authentication server 110 may be provided with a list of devices 102 authorized to access services on the network 104 (e.g., a whitelist). The authentication server 110 further may be provided with a list of devices 102 that are not authorized to access services on the network 104 (e.g., a blacklist) In some configurations, after successful authentication of the device 102 using the device certificate 132, the authentication server 110 may perform further authorization checks using this list before granting network 104 access.

The authentication server 110 may additionally be provided with a service agreement. After validating the device certificate 132 or otherwise validating the credentials of the device 102 to access the network 104, the authentication server 110 may send the device 102 the service agreement or otherwise cause the device 102 to receive information about service agreements required for receiving full service via the network 104. This may be done, for example, by the authentication server 110 configuring the network 104 to cause web access requests to be redirected to a service agreement portal.

The device 102, or the user of the device 102, may be required to accept the service agreement to access services through the network 104. In one configuration, the service agreement may set conditions for using the network 104. In another configuration, the service agreement may include billing information. By agreeing to the service agreement, the user of the device 102 may accept responsibility for paying for the services accessed by the device 102. In another configuration, the service agreement may involve payment of a billing amount using any one of a plurality of well-known payment methods.

Upon successful execution of the service agreement, the authentication server 110 may associate a unique device ID with an account linked to the user responsible for payment. In subsequent visits to the network 104, the authentication server 110 may grant access to an authenticated device 102 without requiring the device 102, or the user of the device 102, to re-accept the service agreement based on the device 102 having previously accepted the service agreement.

The authentication server 110 may also be provided with a network certificate 138 that a device 102 may use to authenticate the network 104. The network certificate 138 may be provided by a CA 112. In one configuration, one root CA 112 may issue network certificates 138 for all NH networks. The root CA 112 may also maintain an OCSP server that devices 102 may query to verify that a network certificate 138 has not been revoked. Having a single CA 112 issue all network certificates 138 may reduce complexity. It may also increase the risk of masquerading NH networks if the CA 112 or a network certificate 138 is compromised.

In another configuration, the root CA 112 may authorize one or more intermediate CAs 112. The intermediate CAs 112 may then issue network certificates 138. In this configuration, the root CA 112 may maintain a revocation list of intermediate CAs 112. Further, an intermediate CA 112 may maintain a revocation list for the certificates the intermediate CA 112 has issued.

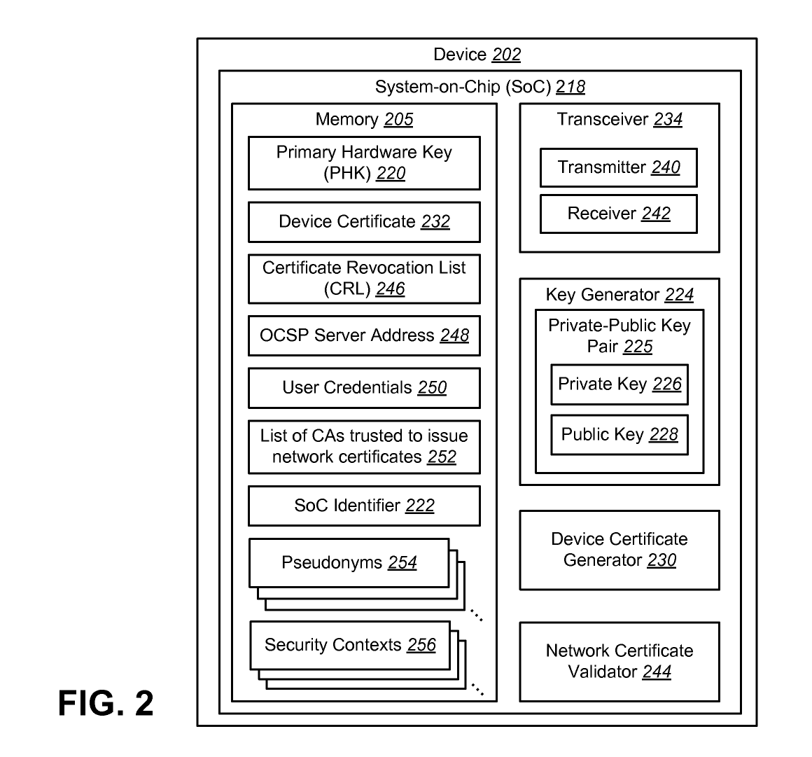

FIG. 2 is a block diagram illustrating an example device 202. The device 202 may include a system-on-chip (SoC) 218. The SoC 218 may include a transceiver 234, a network certificate validator 244, a key generator 224, a device certificate generator 230 and memory 205.

The transceiver 234 may include a transmitter 240 and a receiver 242. The transmitter 240 may enable the device 202 to transmit messages in a wireless communication system 100. The receiver 242 may enable the device 202 to receive messages in the wireless communication system 100. In one example, the transceiver 234 may transmit and receive messages with an access point 106 in a network 104.

The key generator 224 may enable the device 202 to generate one or more private-public key pairs 125 on the SoC 218 of the device 202. A private-public key pair 125 may include a private key 126 and a public key 128. The key generator 224 may generate the one or more private-public key pairs 125 using a primary hardware key (PHK) 120, as described above in connection with FIG. 1. The private key 226 may be protected by a hardware-based root of trust of the SoC 118.

The device certificate generator 230 may enable the device 202 to generate and sign a device certificate 232. The device certificate 132 may include the SoC identifier 222 and the generated public key 228. In one implementation, the device certificate 232 may be formatted as an X.509 certificate. The device certificate generator 230 may generate and sign the device certificate 232 using the SoC identifier 222 and one or more private-public key pairs 225 generated by the key generator 224. The generated device certificate 232 may be signed using the private key 226.

The device 202 may use the device certificate 232 to gain access to a network 104. For example, the device 202 may send the device certificate 232 to the network 104. The network 104 may use the device certificate 232 to authenticate the device 202. The network 104 may use the SoC identifier 222 and the public key 228 included in the device certificate 232 to perform a lookup in a database. In one implementation, the network 104 may access a public key database 116 that stores the SoC identifier 222 (e.g., chip serial numbers(s)) and public keys 228 for one or more devices 202. The network 104 may query the public key database 116 to verify the authenticity of a self-signed device certificate 232.

The network certificate validator 244 may enable the device 202 to validate network certificates 138. For example, the device 202 may receive a network certificate 138 from an authentication server 110. In one configuration, the network certificate validator 244 may validate a network certificate 138 by determining whether the network certificate 138 is signed by a trusted CA 112, whether the network certificate 138 is expired, whether the network certificate 138 is revoked, and/or whether the authentication server 110 is the owner of the network certificate 138.

The device 202 may further include a certificate revocation list (CRL) 246, an OCSP server address 248, user credentials 250, one or more pseudonyms 254, a list 252 of CAs 112 trusted to issue network certificates 138, and one or more security contexts 256 stored in the memory 205.

The network certificate validator 244 may use the CRL 246, the OCSP address, and the list 252 of CAs 112 trusted to issue network certificates 138 to validate a network certificate 138. For example, the network certificate validator 244 may check the CRL 246 or query the OCSP server at the OCSP server address 248 to determine whether a network certificate 138 has been revoked. The network certificate validator 244 may use the list 252 of CAs 112 trusted to issue network certificates 138 to determine whether the network certificate 138 is signed by a trusted CA 112.

The device 202 may use the user credentials 250 in addition to or in place of the device certificate 132 to authenticate to a network 104. For example, a NH network 104 operated by an enterprise may require the device 202 to authenticate using user credentials 250 (e.g., username and password, etc.) as an added security measure.

The device 202 may use the one or more pseudonyms 254 to authenticate to a network 104 that the device 202 has previously authenticated to using the device certificate 132. For example, to enhance user privacy, a network 104 may issue the device 202 a pseudonym 254 or other re-authentication identity after the device 202 successfully authenticates using the device certificate 132. In subsequent attempts to access the network 104, the device 202 may present the pseudonym 254 to the network 104 rather than send the device certificate 132. This may enable the device 202 to avoid sending the device certificate 132 in the clear in subsequent visits to the network 104.

The device 202 may store one or more security contexts 256, with each security context 256 associated with a visited NH network 104. The security context 256 may store information about the network 104, the network certificate 138 of the network 104, a pseudonym 254 associated with the network 104, and the authentication process for the network 104. The device 202 may use the one or more security contexts 256 to reconnect to a previously visited NH network 104.

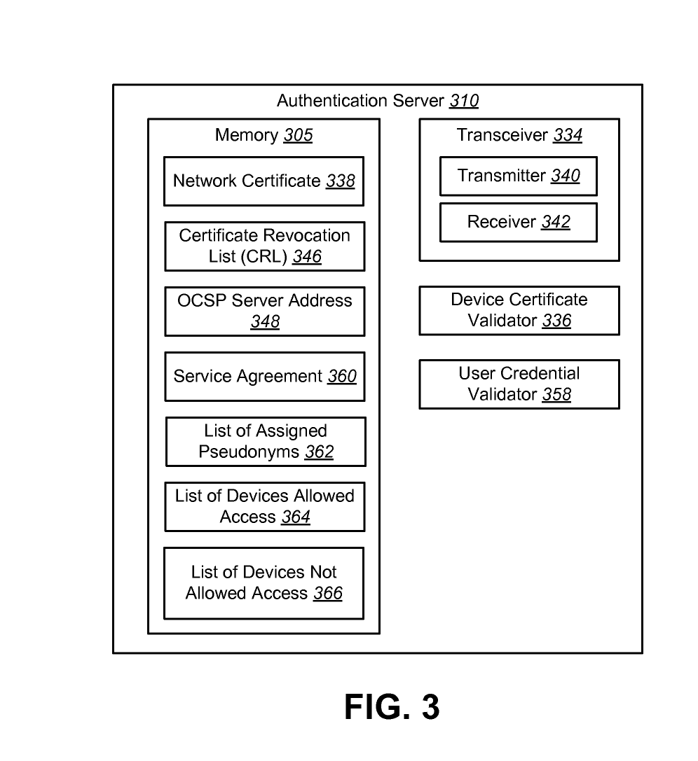

FIG. 3 is a block diagram illustrating an example authentication server 310. The authentication server 310 may comprise a transceiver 334, a device certificate validator 336, a user credential validator 358 and memory 305.

The transceiver 334 may enable the authentication server 310 to transmit and receive messages in a wireless communication system 100. The transceiver 334 may include a transmitter 340 and a receiver 342. The transmitter 340 may enable the authentication server 310 to transmit messages in the wireless communication system 100. The receiver 342 may enable the authentication server 310 to receive messages in the wireless communication system 100.

The device certificate validator 336 may enable the authentication server 310 to validate device certificates 132. The authentication server 310 may receive a device certificate 132 from a device 102. The device certificate 132 may be signed using a private key 126 of the device 102. The device certificate validator 336 may validate the device certificate 132 by querying a public key database 116. In one configuration, the device certificate validator 336 may perform a lookup of the public key database 116 over a trusted out-of-band channel. The out-of-band channel may use hypertext transfer protocol secure (HTTPS). In another configuration, the authentication server 310 may include a local copy of the public key database 116, which it may access locally.

The user credential validator 358 may enable the authentication server 310 to validate user credentials 250. For example, the user credential validator 358 may verify that a password is associated with a username. Other methods for verifying user credentials 250, such as the use of a secure token or biometrics, may also be used.

The authentication server 310 may also comprise a network certificate 338, a CRL 346, an OCSP server address 348, a service agreement 360, a list 362 of assigned pseudonyms 254, a list 364 of devices 102 allowed access to the network 104 (e.g., a whitelist), and a list 366 of devices 102 not allowed access to the network 104 (e.g., a blacklist) stored in the memory 305.

The authentication server 310 may determine whether the device certificate 132 is revoked. To determine whether the device certificate 132 is revoked, the authentication server 310 may verify that the device certificate 132 is not in a CRL 346, or the authentication server 310 may query an OCSP server using the OCSP server address 348.

The authentication server 310 may use the network certificate 338 to authenticate to a device 102. For example, the authentication server 310 may send the network certificate 338 to the device 102. The device 102 may determine whether the network certificate 338 is signed by a trusted CA 112, whether the network certificate 338 is expired, whether the network certificate 338 is revoked, and/or whether the authentication server 310 is the owner of the network certificate 338.

The authentication server 310 may maintain the list 362 of assigned pseudonyms 254 it has issued to devices 102. The authentication server 310 may then use the pseudonym 254 from the device 102 when the device 102 makes subsequent attempts to authenticate to the network 104.

The authentication server 310 may require a device 102 to accept the conditions of the service agreement 360, including information about billing, before authorizing the device 102 to access the network 104.

The authentication server 310 may use the list 364 of devices 102 allowed to access the network 104 and the list 366 of devices 102 not allowed to access the network 104 to determine whether to authorize a device 102 to access the network 104. For example, the authentication server 310 may authorize a device 102 with a valid device certificate 132 if the device 102 is identified in the list 364 of devices 102 allowed to access the network 104. In another example, the authentication server 310 may deny access to a device 102 if the device 102 is identified in the list 366 of devices 102 not allowed to access the network 104, regardless of whether the device 102 has a valid device certificate 132.

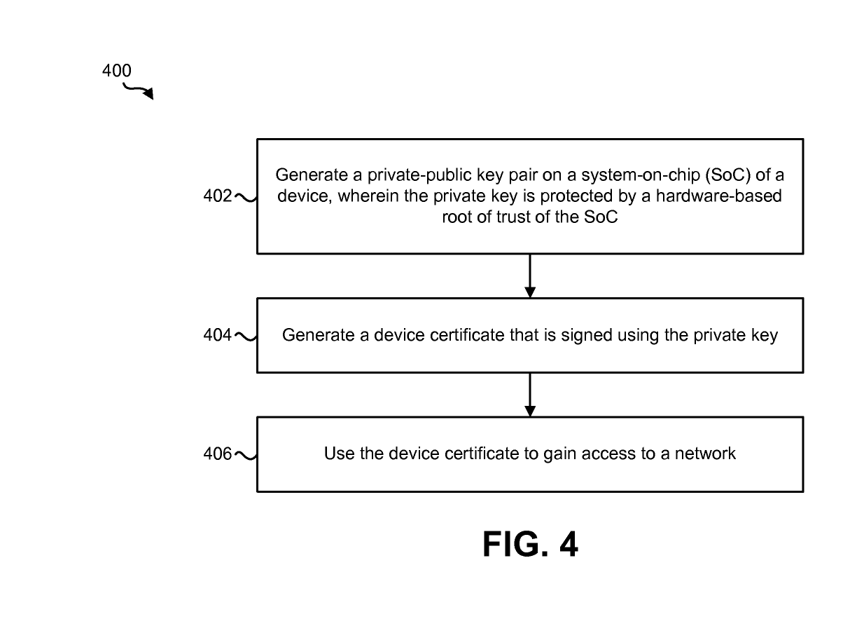

FIG. 4 is a flow diagram illustrating one configuration of a method 400 for authenticating a device 102 to a network using a device certificate 132. The method 400 may be performed by a device 102. The device 102 may be capable of communicating with a network 104. The network 104 may be a neutral-host (NH) network. In one configuration, the network 104 may be a NH LTE network. In another configuration, the network 104 may be an IEEE 802.11 (WiFi) NH network.

The device 102 may generate 402 a private-public key pair 125 on a system-on-chip (SoC) 118 of the device 102. The private key 126 may be protected by a hardware-based root of trust of the SoC 118. For example, the private-public key pair 125 may be generated using a primary hardware key (PHK) 120 that is stored in one-time programmable memory of the SoC 118. The device 102 may use the PHK 120 to generate one or more private-public key pairs 125 using asymmetric cryptosystems, such as Rivest-Shamir-Adleman (RSA) or elliptic curve cryptography (ECC). The private key 126 may be protected by a trusted execution environment. The trusted execution environment may be an isolated area or execution environment of the SoC 118 that provides a higher level of security than the operating system of the device 102.

The device 102 may generate 402 the private-public key pair 125 at various times. For example, the device 102 may generate 402 the private-public key pair 125 before activating service on a network 104 (e.g., a NH network) or the first boot of the device 102. In one example, the private-public key pair 125 may be generated 402 during the manufacturing of the SoC 118. In another example, the private-public key pair 125 may be generated 402 during device 102 manufacture.

In one implementation, the public keys 128 along with an SoC identifier 122 (e.g., SoC serial number or other device-unique serial number) may be stored in a public key database 116 for subsequent use. For example, the network 104 may use the public key database 116 to authenticate the device 102.

The device 102 may generate 404 a device certificate 132 that is signed using the private key 126. In one implementation, the device certificate 132 may be formatted as an X.509 certificate. The device certificate 132 may include the SoC identifier 122 and the public key 128. The generated device certificate 132 may be signed using the private key 126.

The device 102 may generate 404 and sign the device certificate 132 at various times. For example, device 102 may generate 404 and sign the device certificate 132 during a first boot of the device 102. In another example, the device 102 may generate 404 and sign the device certificate 132 as part of activating NH network service of the device 102. In yet another example, the device 102 may generate 404 and sign the device certificate 132 as part of the authentication process with the network 104.

The device 102 may use 406 the device certificate 132 to gain access to the network 104. For example, the device 102 may send an access request to the network 104. The device 102 may receive a network certificate 138 from the network 104. The device 102 may validate the network certificate 138. The device 102 may send the device certificate 132 to the network 104. The device 102 may receive access to the network 104 based on the device certificate 132.

In the case where the network 104 is an LTE network, these steps to gain access to the network 104 may be performed using Extensible Authentication Protocol (EAP) over the Non-Access Stratum (NAS) of the LTE network 104. In one implementation, these steps may be performed using EAP-TLS (Transport Layer Security) or EAP-TTLS (Tunneled Transport Layer Security).

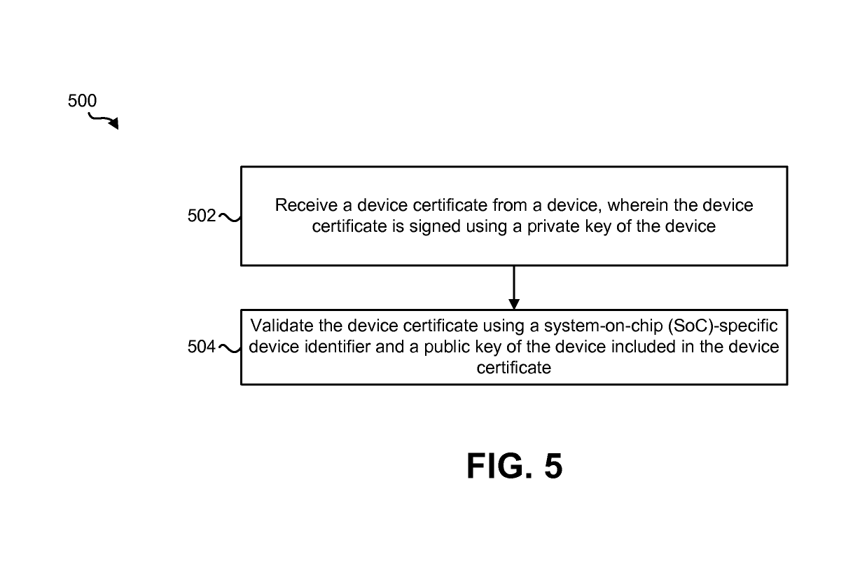

FIG. 5 is a flow diagram illustrating another configuration of a method 500 for authenticating a device 102 to a network 104 using a device certificate 132. In one configuration, the method 500 may be implemented by an authentication server 110 (or other network entity) included in the network 104. The device 102 may be capable of communicating with the network 104 (via an access point 106, for instance). In one configuration, the network 104 may be a neutral-host (NH) network.

The authentication server 110 (or other network entity) may receive 502 a device certificate 132 from the device 102. The authentication server 110 may receive 502 the device certificate 132 as part of a process to authenticate the device 102 for service on the network 104. The device certificate 132 may be signed using a private key 126 of the device 102. The device certificate 132 may include a system-on-chip (SoC 118)-specific device identifier 122 (e.g., chip serial numbers(s)) and a public key 128.

The authentication server 110 (or other network entity) may validate 504 the device certificate 132 using the SoC identifier 122 and the public key 128 included in the device certificate 132. In an implementation, the authentication server 110 may be provided with access to a public key database 116 that stores the SoC identifier 122 and public keys 128 for one or more devices 102 with the self-signed device certificates 132. The authentication server 110 may query the public key database 116 to verify the authenticity of a self-signed device certificate 132.

In one configuration, the public key database 116 may reside on a separate network entity that may be inside or outside an operator network 104. In this configuration, the authentication server 110 may query the public key database 116 over a trusted out-of-band channel. The out-of-band channel may use a secure protocol, such as hypertext transfer protocol secure (HTTPS).

In another configuration, the authentication server 110 may include a local copy of the public key database 116, which it may access locally. In this configuration, validating 504 the device certificate 132 may include performing a lookup in the public key database 116. In this case, the lookup is performed in the local public key database 116.

In yet another configuration, validating 504 the device certificate 132 may be performed by generating the hash (e.g., SHA-256 hash) of the SoC identifier 122, the public key 128 of the self-signed device certificate 132, and a database-specific seed value. The authentication server 110 (or other network entity) may use the hash to perform a lookup in the public key database 116.

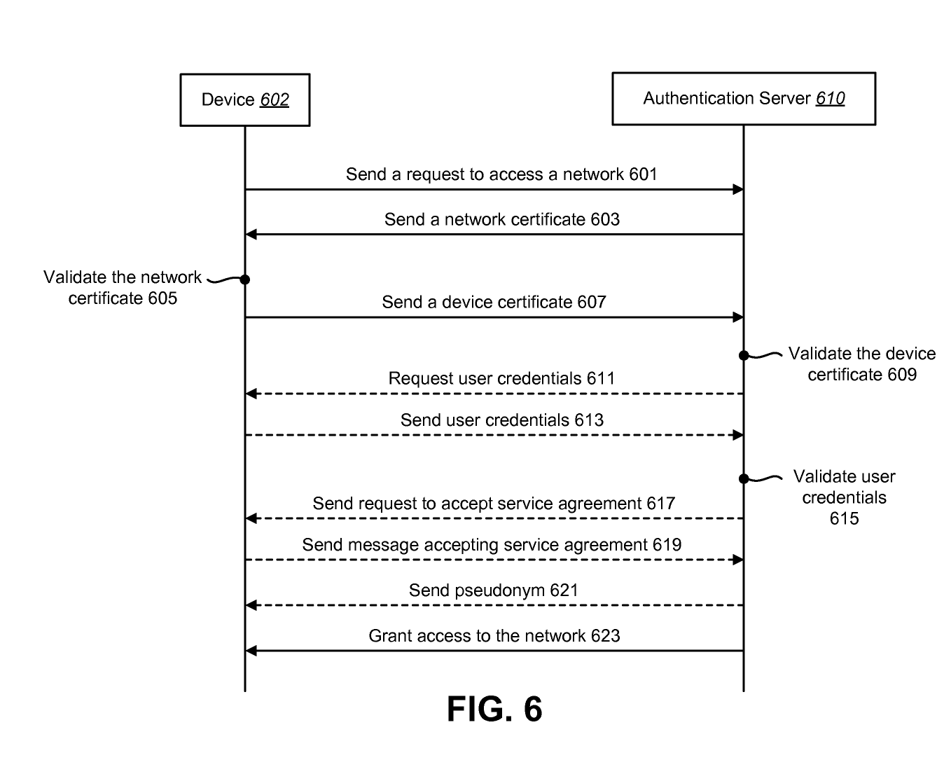

FIG. 6 is a sequence diagram illustrating a procedure for certificate-based authentication. In FIG. 6, a device 602 may be capable of communicating with a network 104. In one configuration, the network 104 may be a neutral-host (NH) network. The network 104 may include an authentication server 610.

A device 602 may send 601 a request to access a network to the authentication server 610. In response, the authentication server 610 may send 603 a network certificate 138 to the device 602.

The device 602 may validate 605 the network certificate 138. To validate 605 the network certificate 138, the device 602 may determine whether the network certificate 138 is signed by a trusted CA 112. The device 602 may make this determination based on a stored list 252 of CAs 112 trusted to issue network certificates 138. The device 602 may further determine whether the network certificate 138 is expired. The device 602 may compare the expiration date of the network certificate 138 with the current date. If the current date is later than the expiration date, the device 602 may determine that the network certificate 138 is expired.

To validate 605 the network certificate 138, the device 602 may also determine whether the network certificate 138 is revoked. To determine whether the network certificate 138 is revoked, the device 602 may verify that the network certificate 138 is not in a CRL 246, or the device 602 may query a certificate-status server 114 (e.g., OCSP server).

To validate 605 the network certificate 138, the device 602 may still further determine whether the authentication server 610 owns the network certificate 138. To determine whether the authentication server 610 owns the network certificate 138, the device 602 may encrypt a message using a public key in the network certificate 138 and then verify that the authentication server 610 is able to correctly decrypt the message, thereby demonstrating that the authentication server 610 possesses the private key associated with the network certificate 138.

The device 602 may then send 607 a device certificate 132 to the authentication server 610. The device certificate 132 may be a self-signed device certificate 132. For example, the device 602 may generate a private-public key pair 125 as described above in connection with FIG. 1. The device 602 may also generate the device certificate 132 as described in connection with FIG. 1. The device certificate 132 may be signed using the private key 126. In one implementation, the device certificate 132 may be formatted as an X.509 certificate. The device certificate 132 may include an SoC identifier 122 and the public key 128.

In one configuration, to avoid sending the device certificate 132 in the clear, the device 602 may encrypt the device certificate 132 using the public key in the network certificate 138. The authentication server 610 may decrypt the device certificate 132, if necessary, and then 609 validate the device certificate 132.

To validate 609 the device certificate 132, the authentication server 610 may query the public key database 116 using the SoC identifier 122 and the public key 128 provided in the device certificate 132. This may be accomplished as described in connection with FIG. 1.

To validate 609 the device certificate 132, the authentication server 610 may also determine whether the device certificate 132 is expired. The authentication server 610 may compare the expiration date of the device certificate 132 with the current date. If the current date is later than the expiration date, the authentication server 610 may determine that the device certificate 132 is expired. The authentication server 610 may also determine whether the device certificate 132 is revoked. To determine whether the device certificate 132 is revoked, the authentication server 610 may verify that the device certificate 132 is not in a CRL 246, or the authentication server 610 may query an OCSP server. The authentication server 610 may also determine whether the device 602 owns the device certificate 132. To determine whether the device 602 owns the device certificate 132, the authentication server 610 may encrypt a message using the public key 128 in the device certificate 132 and then verify that the device 602 is able to correctly decrypt the message, thereby demonstrating that the device 602 possesses the private key 126 associated with the device certificate 132.

In one configuration, the authentication server 610 may further determine whether the device 602 is in a list 364 of devices 602 that are allowed access to the network 104 (i.e., a whitelist). In another configuration, the authentication server 610 may determine whether the device 602 is in a list 366 of devices 602 that are not allowed access to the network 104 (i.e., a blacklist) In yet another configuration, the authentication server 610 may check the whitelist or the blacklist instead of determining whether the device certificate 132 is revoked.

The authentication server 610 may (optionally) request 611 user credentials 250 from the device 602. The device 602 may send 613 user credentials 250. The authentication server 610 may validate 615 the user credentials 250. For example, the authentication server 610 may verify that a password is associated with a username. Other methods for verifying user credentials 250, such as the use of a secure token or biometrics, may also be used.

The authentication server 610 may (optionally) send 617 the device 602 a request to accept a service agreement 360. The message may include a copy of the service agreement 360. The service agreement 360 may specify conditions for network 104 access. The service agreement 360 may also comprise billing information associated with network 104 access. The device 602 may send 619 a message to the authentication server 610 accepting the service agreement 360.

The authentication server 610 may (optionally) send 621 a pseudonym 254 or other re-authentication identity to the device 602. In subsequent visits to the network 104, the device 602 may use the pseudonym 254 in place of the device certificate 132 to authenticate to the network 104. Using the pseudonym 254 in place of the device certificate 132 may enhance user privacy.

The authentication server 610 may then grant 623 the device 602 access to the network 104. The access may (optionally) be governed by the service and billing conditions set forth in the service agreement 360.

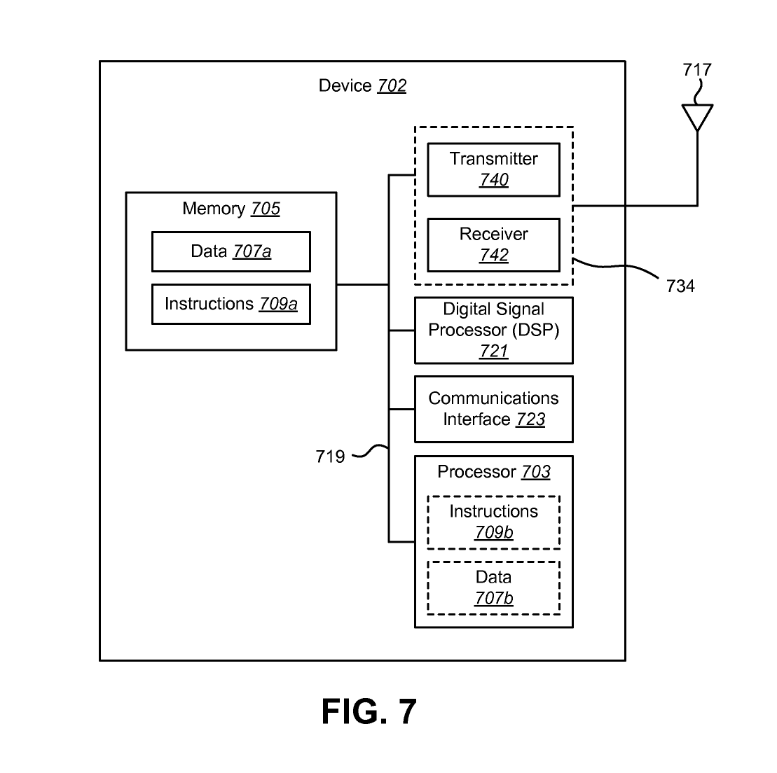

FIG. 7 shows certain components that may be included in a device 702. The device 702 described in connection with FIG. 7 may be an example of and/or may be implemented in accordance with one or more of the devices 102, 202, 602, described in connection with one or more of FIGS. 1-6.

The device 702 includes a processor 703. The processor 703 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 703 may be referred to as a central processing unit (CPU). Although just a single processor 703 is shown in the device 702 of FIG. 7, in an alternative configuration, a combination of processors (e.g., an ARM and DSP) could be used.

The device 702 also includes memory 705 in electronic communication with the processor (i.e., the processor can read information from and/or write information to the memory). The memory 705 may be any electronic component capable of storing electronic information. The memory 705 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 707a and instructions 709a may be stored in the memory 705. The instructions may include one or more programs, routines, sub-routines, functions, procedures, code, etc. The instructions may include a single computer-readable statement or many computer-readable statements. The instructions 709a may be executable by the processor 703 to implement the methods disclosed herein. Executing the instructions 709a may involve the use of the data 707a that is stored in the memory 705. When the processor 703 executes the instructions 709, various portions of the instructions 709b may be loaded onto the processor 703, and various pieces of data 707b may be loaded onto the processor 703.

The device 702 may also include a transmitter 740 and a receiver 742 to allow transmission and reception of signals to and from the device 702 via an antenna 717. The transmitter 740 and receiver 742 may be collectively referred to as a transceiver 734. The device 702 may also include (not shown) multiple transmitters, multiple antennas, multiple receivers and/or multiple transceivers.

The device 702 may include a digital signal processor (DSP) 721. The device 702 may also include a communications interface 723. The communications interface 723 may allow a user to interact with the device 702.

The various components of the device 702 may be coupled together by one or more buses, which may include a power bus, a control signal bus, a status signal bus, a data bus, etc. For the sake of clarity, the various buses are illustrated in FIG. 7 as a bus system 719.

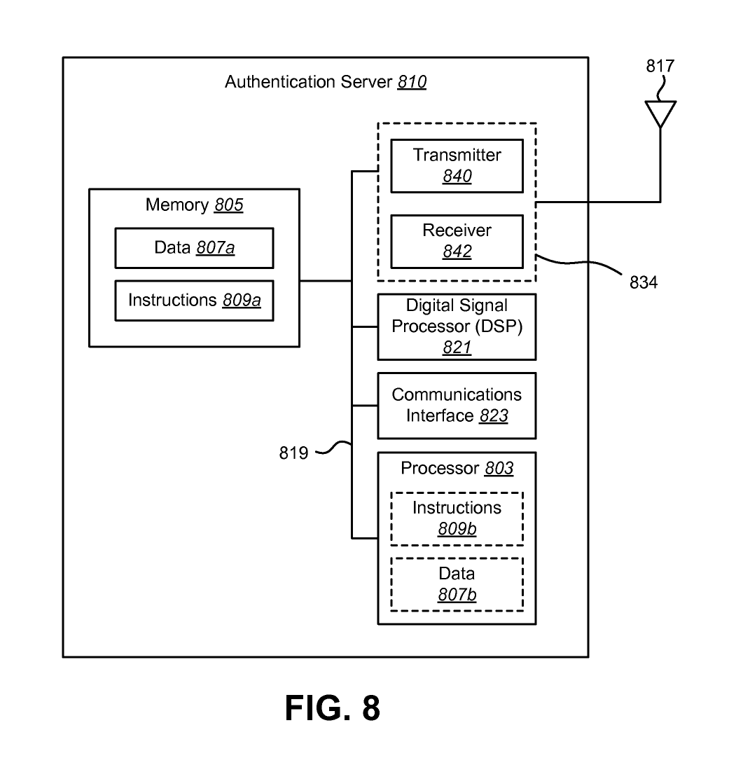

FIG. 8 shows certain components that may be included in an authentication server 810. The authentication server 810 described in connection with FIG. 8 may be an example of and/or may be implemented in accordance with one or more of the authentication servers 110, 310, 610, described in connection with one or more of FIGS. 1-6.

The authentication server 810 includes a processor 803. The processor 803 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 803 may be referred to as a central processing unit (CPU). Although just a single processor 803 is shown in the authentication server 810 of FIG. 8, in an alternative configuration, a combination of processors (e.g., an ARM and DSP) could be used.

The authentication server 810 also includes memory 805 in electronic communication with the processor (i.e., the processor can read information from and/or write information to the memory). The memory 805 may be any electronic component capable of storing electronic information. The memory 805 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 807a and instructions 809a may be stored in the memory 805. The instructions may include one or more programs, routines, sub-routines, functions, procedures, code, etc. The instructions may include a single computer-readable statement or many computer-readable statements. The instructions 809a may be executable by the processor 803 to implement the methods disclosed herein. Executing the instructions 809a may involve the use of the data 807a that is stored in the memory 805. When the processor 803 executes the instructions 809, various portions of the instructions 809b may be loaded onto the processor 803, and various pieces of data 807b may be loaded onto the processor 803.

The authentication server 810 may also include a transmitter 840 and a receiver 842 to allow transmission and reception of signals to and from the authentication server 810 via an antenna 817. The transmitter 840 and receiver 842 may be collectively referred to as a transceiver 834. The authentication server 810 may also include (not shown) multiple transmitters, multiple antennas, multiple receivers and/or multiple transceivers.

The authentication server 810 may include a digital signal processor (DSP) 821. The authentication server 810 may also include a communications interface 823. The communications interface 823 may allow a user to interact with the authentication server 810.

The various components of the authentication server 810 may be coupled together by one or more buses, which may include a power bus, a control signal bus, a status signal bus, a data bus, etc. For the sake of clarity, the various buses are illustrated in FIG. 8 as a bus system 819.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as illustrated by FIGS. 4-6, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A method for authenticating a device to a network using a device certificate, comprising:
generating a private-public key pair on a system-on-chip (SoC) of the device, wherein the private key is protected by a hardware-based root of trust of the SoC;
generating a device certificate that is signed using the private key; and
using the device certificate to gain access to the network.

2. The method of claim 1, wherein the device certificate includes an SoC identifier.

3. The method of claim 1, wherein the device certificate further includes the generated public key.

4. The method of claim 1, wherein the private-public key pair is generated using a primary hardware key.

5. The method of claim 1, wherein the device certificate is formatted as an X.509 certificate.

6. The method of claim 1, wherein the network is a neutral host (NH) network.

7. The method of claim 6, wherein the NH network is a long-term evolution (LTE) NH network.

8. The method of claim 6, wherein the NH network is an Institute of Electrical and Electronics Engineers (IEEE) 802.11 (WiFi) access network.

9. The method of claim 1, wherein using the device certificate to gain access to the network comprises:
sending an access request to the network;
receiving a network certificate from the network;
validating the network certificate;
sending the device certificate to the network; and
receiving access to the network based on the device certificate.

10. The method of claim 9, wherein the steps of sending an access request to the network, receiving a network certificate from the network, validating the network certificate, sending the device certificate to the network, and receiving access to the network based on the device certificate are performed using Extensible Authentication Protocol (EAP) over a Non-Access Stratum (NAS) of an LTE network.

11. The method of claim 9, wherein the steps of sending an access request to the network, receiving a network certificate from the network, validating the network certificate, sending the device certificate to the network, and receiving access to the network based on the device certificate are performed using EAP-TLS (Transport Layer Security) or EAP-TTLS (Tunneled Transport Layer Security).

12. The method of claim 1, wherein generating the private-public key pair is performed before activating NH network service.

13. The method of claim 1, wherein generating the private-public key pair is performed during device manufacture.

14. The method of claim 1, wherein generating the private-public key pair is performed during SoC manufacture.

15. The method of claim 1, wherein generating the device certificate is performed during a first boot of the device.

16. The method of claim 1, wherein generating the device certificate is performed during activation of NH network service.

17. The method of claim 1, wherein generating the device certificate is performed as part of authentication to the network.

18. An apparatus for authenticating a device to a network using a device certificate, comprising:
a key generator configured to generate a private-public key pair on a system-on-chip (SoC) of the device, wherein the private key is protected by a hardware-based root of trust of the SoC;
a certificate generator configured to generate a device certificate that is signed using the private key; and
a transceiver configured to use the device certificate to gain access to the network.

19. The apparatus of claim 18, wherein the device certificate includes an SoC identifier.

20. The apparatus of claim 18, wherein the device certificate further includes the generated public key.

21. The apparatus of claim 18, wherein the private-public key pair is generated using a primary hardware key.

22. The apparatus of claim 18, wherein the network is a neutral host (NH) network.

23. The apparatus of claim 18, wherein generating the device certificate is performed as part of authentication to the network.

24. A method for authenticating a device to a network using a device certificate, comprising:
receiving a device certificate from a device, wherein the device certificate is signed using a private key of the device; and
validating the device certificate using a system-on-chip (SoC)-specific device identifier and a public key of the device included in the device certificate.

25. The method of claim 24, wherein validating the device certificate comprises performing a lookup in a database.

26. The method of claim 25, wherein the lookup is performed over a trusted out-of-band channel, and wherein the out-of-band channel uses hypertext transfer protocol secure (HTTPS).

27. The method of claim 25, wherein the lookup is performed in a local database in the network.

28. The method of claim 25, wherein the lookup is performed by generating a hash of the SoC identifier, the public key and a database-specific seed value.

29. An apparatus for authenticating a device to a network using a device certificate, comprising:
a transceiver configured to receive a device certificate from a device, wherein the device certificate is signed using a private key of the device; and
a certificate validator configured to validate the device certificate using a system-on-chip (SoC)-specific device identifier and a public key of the device included in the device certificate.

30. The apparatus of claim 29, wherein validating the device certificate comprises performing a lookup in a database.
